(19) United States
(12) Patent Application Publication
(10) Pub. No.: US 2008/0222385 A1
(43) Pub. Date: Sep. 11, 2008

(54) PARAMETER SETTING METHOD AND APPARATUS FOR NETWORK CONTROLLER

(76) Inventor: Chia-Hua Hsu, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/043,966

(22) Filed: Mar. 7, 2008

(30) Foreign Application Priority Data
Mar. 9, 2007 (TW) 096108299

(51) Int. Cl. G06F 12/00

(52) U.S. Cl. 711/207; 711/E12.059

(57) ABSTRACT

A method for setting at least one of parameters of a peripheral device coupled to a host includes: executing a program code stored in a first storage unit of a host to obtain setting data corresponding to the at least one of the parameters; storing the setting data into a second storage unit of the host; generating an indication signal to the peripheral device to indicate that the setting data has been stored in the second storage unit; transferring the setting data from the second storage unit of the host to the peripheral device; and performing a function of the peripheral device according to the setting data.

### BACKGROUND OF THE INVENTION

1. Field of the Invention

The present invention relates to a computer peripheral device, and more particularly, to a parameter setting method for computer peripheral device.

2. Description of the Prior Art

As the communication technology progresses, a network controller becomes an essential component in a computer system nowadays. Certain parameters of a medium access controller (MAC) within the network controller need to be set properly in an initial state. Generally speaking, related setting parameters for the medium access controller, such as a medium access control (MAC) address, etc., are stored in an EEPROM in advance. Therefore, when the computer system is turned on, the medium access controller reads the setting parameters from the EEPROM to complete the initialization.

However, this setting method of the medium access controller needs an external memory such as the aforementioned EEPROM for storing the related setting parameters. Therefore, the overall cost cannot be decreased.

### SUMMARY OF THE INVENTION

It is an objective of the claimed invention to provide a method for setting a parameter of a network controller by utilizing a BIOS to solve the above-mentioned problems.

According to one embodiment of the present invention, a method for setting at least one of parameters of a peripheral device coupled to a host is disclosed. The parameter setting method comprises: executing a program code stored in a BIOS memory of the host to obtain setting data, wherein the setting data corresponds to at least one of the parameters; storing the setting data in a storage unit of the host; generating an indication signal to the peripheral device to indicate that the setting data has been stored in the second storage unit; transferring the setting data from the storage unit of the host to the peripheral device; and performing a function of the peripheral device according to the setting data.

According to one embodiment of the present invention, an apparatus for communicating with a host is disclosed. The network controller comprises: a host interface, coupled to the host comprising a CPU, a first memory, and a second memory; a controller, coupled to the host interface; and a control register, for storing a setting data from the second memory of the host, where the host executes a program code stored in the first memory of the host to obtain the setting data and stores the setting data in the second memory, and transfers the setting data from the second memory of the host to the control register, wherein the controller performs a predetermined function according to the setting data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates related apparatus of a network controller performing a parameter setting method according to one embodiment of the present invention.

FIG. 2 is a first embodiment of the parameter setting method performed by the network controller.

FIG. 3 is a second embodiment of the parameter setting method performed by the network controller.

### DETAILED DESCRIPTION

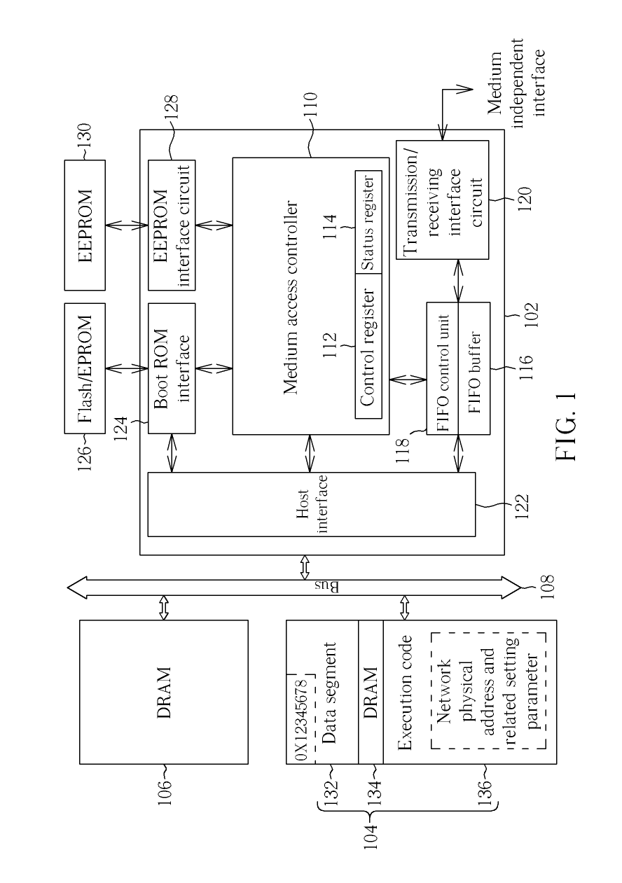

Please refer to FIG. 1. FIG. 1 illustrates related apparatuses of a network controller performing a parameter setting method according to one embodiment of the present invention. As shown in FIG. 1, the apparatus comprises a network controller 102, a BIOS 104, a dynamic random access memory (DRAM) 106 and a bus 108. The network controller 102 is utilized for controlling and transmitting packet data between a host and a media independent interface (MII). The BIOS 104 is utilized for storing a software program code. The DRAM 106 is utilized for dynamically storing program(s) and related data used by the host. The bus 108 is utilized as signal transmission line(s) among the network controller, the BIOS and the DRAM.

As shown in FIG. 1, the network controller 102 of this embodiment comprises: a medium access controller 110, for processing packet data; a control register 112, for storing a network physical address and related parameter data required by the network controller 102; a first in first out (FIFO) buffer 116, for buffering the packet data; a control unit 118, for controlling the FIFO buffer 116; a transmission/receiving interface circuit 120, for transmitting the packet data to the medium independent interface (MII) or receiving the packet data from the medium independent interface; a host interface 122, for being utilized as a transmission interface between the network controller 102 and the host, such as a PCI interface or a PCI-E interface; a Boot ROM interface 124, for being utilized as a transmission interface between the network controller 102 and a Flash/EPROM; and a EEPROM interface circuit 130, for being utilized as a transmission interface between the network controller 102 and an EEPROM.

Additionally, please refer to the BIOS 104 shown in FIG. 1. The BIOS 104 is utilized for storing a software program code for performing a power-on self test, peripheral hardware initialization, loading operation system to DRAM, etc. Generally speaking, the software program code stored in the BIOS 104 can be divided into three portions, that is, a data segment 132, a loader 134, and an execution code 136. The portion of the data segment 132 and the partial portion of the loader 134 are nonupdatable portions of the program code, while the execution code 136 is an updatable portion of the program code. According to one embodiment of the present invention, the network physical address and the related setting parameter required by the medium access controller 110 can be pre-compressed into the updatable execution code of the BIOS, and an offset address is further stored into the nonupdatable data segment. Therefore, when the computer system is in a power-on initial state, the medium access controller 102 can utilize the BIOS 104 to set the network physical address and the related setting parameters. Detailed operation principles are further described in the following.

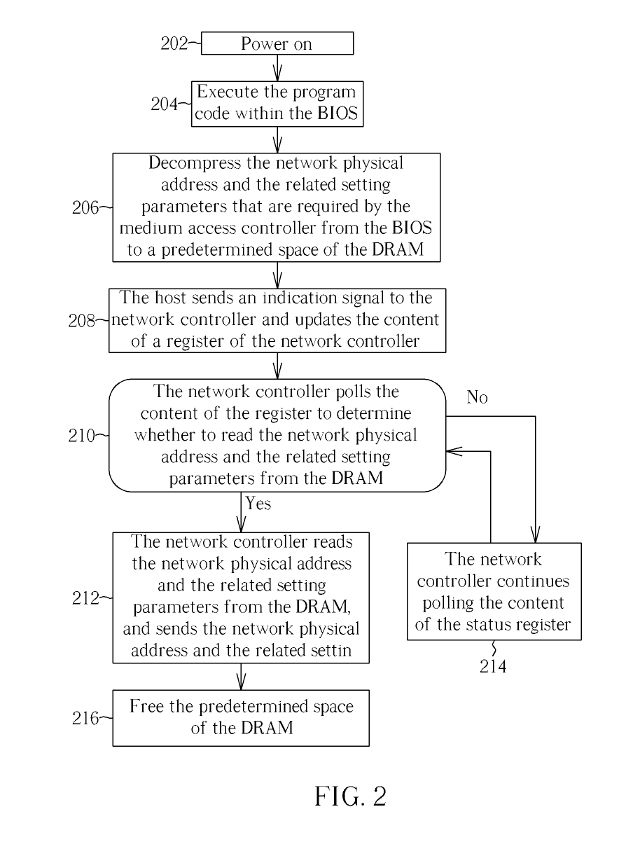

Please refer to FIG. 2. FIG. 2 is a flow chart of a first embodiment of the parameter setting method of the network controller. The steps are described as follows.

Step 202: Power on.

Step 204: Execute the program code within the BIOS.

Step 206: Decompress the network physical address and the related setting parameters that are required by the medium access controller from the BIOS to a predetermined space of the DRAM.

Step 208: The host sends an indication signal to the network controller and updates the content of a register of the network controller.

Step 210: The network controller polls the content of the register to determine whether to read the network physical address and the related setting parameters from the DRAM. If the content of the register satisfies a condition, which is suitable for performing reading, execute Step 212; if the content of the register dissatisfies the condition, which is suitable for performing reading, execute Step 214.

Step 212: The network controller reads the network physical address and the related setting parameters from the DRAM, and sends the network physical address and the related setting parameters to the control register, and then the flow enters Step 216.

Step 214: The network controller continues polling the content of the status register, and then the flow re-enters Step 210.

Step 216: Free the predetermined space of the DRAM.

In this embodiment, a designer of the BIOS 104 may write and store the partial setting program of the network controller and the network data required by compressing into the BIOS 104 in advance. The network data is the network physical address and the related setting parameters required by the medium access controller 110, and is compressed into the updatable execution code 136 of the BIOS 104. In addition, the network data further comprises an offset address, where the offset address is stored in the nonupdatable data segment of the BIOS 104. Therefore, when the BIOS 104 executes the segment of the program for setting the network controller, the network physical address and the related setting parameters are decompressed from the BIOS 104 and are stored into a predetermined space of the DRAM 106 (in step 206). The start address of the predetermined space is located at the offset address stored in the BIOS. Then after the network physical address and the related setting parameters are stored into the DRAM 106, the host sends an indication signal to the network controller 102 and updates the content of the status register 114 of the network controller 102 (in step 208), in order to remind the network controller 102 that the required network data is stored in the DRAM 106 and is able to be accessed.

According to this embodiment, the network controller 102 continues polling the content of the status register to determine whether the related network data is stored in the DRAM 106 (in step 210). For example, the content of the status register 114 being logic 0 represents that the network data is not stored in the DRAM 106; on the contrary, the content of the status register 114 being logic 1 represents that the network data is stored in the DRAM 106. Therefore, after the content of the status register 114 is changed from logic 0 to logic 1, the network controller 102 utilizes the direct memory access (DMA) unit (not shown) to access the network data from the predetermined space of the DRAM 106, and stores the network data into the control register 112 (in step 210). Then after completing the network data setting, the operation system of the host can free the network data stored in the predetermined space (in step 216) in order to prevent from wasting the resource of the DRAM 106.

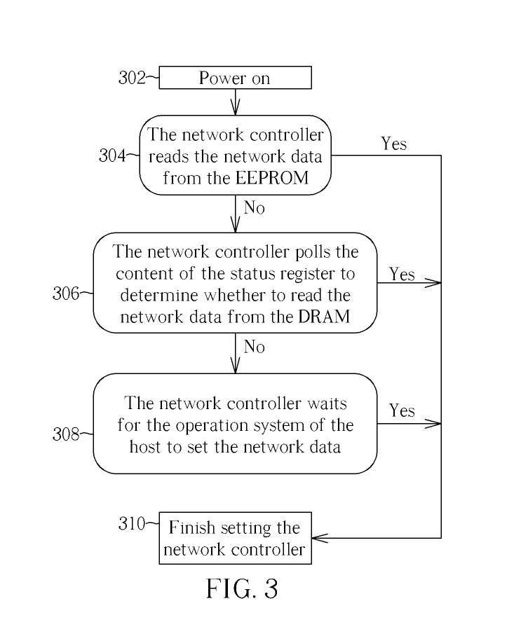

Please refer to FIG. 3. FIG. 3 is a flow chart of a second embodiment of the parameter setting method of the network controller. The steps are described as follows.

Step 302: Power on.

Step 304: The network controller reads the network data from the EEPROM. If the network data exists in the EEPROM, execute Step 310; if no network data exists in the EEPROM, execute Step 306.

Step 306: The network controller polls the content of the status register to determine whether to read the network data from the DRAM. If the content of the status register satisfies a condition, which is suitable for performing reading, execute Step 310; if the content of the status register dissatisfies the condition, which is suitable for performing reading, execute Step 308.

Step 308: The network controller waits for the operation system of the host to set the network data, and execute Step 310.

Step 310: Finish setting the network controller.

In this embodiment, at the initial state, the network controller 102 reads the network data from the EEPROM 130 (in step 304). If the network data exists in the EEPROM 130, the network data is accessed and the network controller 102 completes the setting operation. On the contrary, if no network data exists in the EEPROM 130, the network controller 102 reads the network data from the DRAM 106 (in Step 306). However, the network data stored in the DRAM 106 is decompressed from the BIOS 104, the related setting methods are described in the first embodiment. Then if there is still no network data in the DRAM 106, that is, the content of the status register 112 of the network controller 102 is still logic 0, and a predetermined time is expired, the network controller 102 utilizes the operation system of the host to set the network data (in step 308). Because the technology mentioned in step 308 is well known to the skilled in the art, the detailed description is omitted.

As mentioned above, the present invention utilizes the BIOS 104 of the host to provide the network data required by the network controller 102. And according to the auto-load mechanism of the network controller 102, the network controller 102 reads the required network data from the DRAM 106 to enhance the flexibility of utilization of the EEPROM 130. Furthermore, although the network controller 102 receiving the required network data from the BIOS 104 is used as an example, it is not meant to limit the scope of the invention. Other kinds of peripheral circuits, such as a control circuit of a card reader, a control circuit of an optical disc drive, etc., whose parameters required to be set are provided by the BIOS 104, are in the scope of the present invention.

Those skilled in the art will readily observe that numerous modifications and alterations of the device and method may be made while retaining the teachings of the invention.

What is claimed is:

1. A method for setting at least one of parameters of a peripheral device, comprising:
executing a program code stored in a first storage unit of a host to obtain setting data corresponding to the at least one of the parameters;
storing the setting data in a second storage unit of the host;
generating an indication signal to the peripheral device to indicate that the setting data has been stored in the second storage unit;
transferring the setting data from the second storage unit of the host to the peripheral device; and
performing a function of the peripheral device according to the setting data.

2. The method of claim 1, further comprising:
releasing space of the second storage unit which is utilized to store the setting data.

3. The method of claim 1, further comprising:
changing the content of the register of the peripheral device according to the indication signal.

4. The method of claim 3, further comprising:
determining whether to transfer the setting data from the second storage unit to the peripheral device by polling the content of the register of the peripheral device.

5. The method of claim 1, wherein the peripheral device is a network communication device and the setting data comprises a Media Access Control (MAC) address.

6. The method of claim 5, wherein the setting data comprises a memory start address which represents a start address of the setting data stored in the second storage unit.

7. The method of claim 5, wherein the setting data comprises a memory start address and the memory start address is stored at a non-updatable region of the program code, and the MAC address is stored at an updatable region of the program code.

8. The method of claim 1, wherein the first storage unit is a basic input/output system (BIOS) memory and the second storage unit is a dynamic random access memory (DRAM).

9. The method of claim 1, wherein the program code is executed in an initiation state.

10. An apparatus for communicating with a host, comprising:
a host interface coupled to the host comprising a CPU, a first memory, and a second memory;
a controller, coupled to the host interface; and
a control register, for storing a setting data from the second memory of the host;
wherein the host executes a program code stored in the first memory of the host to obtain the setting data and stores the setting data in the second memory, and transfers the setting data from the second memory of the host to the control register;
wherein the controller performs a predetermined function according to the setting data.

11. The apparatus of claim 10, further comprising:
a direct memory access (DMA) circuit, for accessing the setting data from the second memory of the host to the control register.

12. The apparatus of claim 10, wherein the first memory is a basic input output system (BIOS) memory.

13. The apparatus of claim 10, wherein the host generates an indication signal to the controller to indicate that the setting data has been stored in the second memory.

14. The apparatus of claim 13, further comprising:
a status register, for storing the indication signal from the host.

15. The apparatus of claim 10, wherein the apparatus is a network device, and the setting data comprises a Media Access Control (MAC) address.

16. The apparatus of claim 15, wherein the MAC address is stored at an updatable region of the program code.

17. The apparatus of claim 10, wherein the setting data comprises a memory start address, which represents a start address of the setting data stored in the second memory.

18. The apparatus of claim 17, wherein the memory start address is stored at a non-updatable region of the program code.

19. A method for setting a setting data of a network controller of a network device which is coupled to a host, the method comprising:
receiving a first setting data from a first memory of the network device and setting the first setting data into the network controller when the first setting data is stored in the first memory of the network device;
checking a value of a state register of the network controller to determine whether to transfer a second setting data from a second memory of the host to the network controller when the first setting data is not stored in the first memory of the network device or the first memory is not located in the network device; and
setting a third setting data produced from an operation system (OS) of the host into the network controller when the value of the state register is not changed;
wherein the value of the state register is changed according to an indication signal from the host.

20. The method of claim 19, wherein the checking step further comprising:
executing a program code stored in a first storage unit of the host to obtain the second setting data;
generating the indication signal to the network controller to indicate that the second setting data has been stored in the host; and
changing the value of the state register according to the indication signal from the host.

21. The method of claim 20, wherein the first storage unit is a basis input/output system (BIOS) memory.

22. The method of claim 20, wherein the second setting data comprises a Media Access Control (MAC) address and a memory start address.

23. The apparatus of claim 15, wherein the MAC address is stored at an updatable region of the program code.

24. The apparatus of claim 10, wherein the setting data comprises a memory start address, which represents a start address of the setting data stored in the second memory.

25. The apparatus of claim 24, wherein the memory start address is stored at a non-updatable region of the program code.
